(19) United States
(12) Patent Application Publication
(10) Pub. No.: US 2006/0206369 A1
(43) Pub. Date: Sep. 14, 2006

(54) Collection method of and collection system for collecting costs of energy-saving facilities

(76) Inventors: Toshihiko Fukushima, Tsuchiura (JP); Tadakatsu Nakajima, Chiyoda (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/433,509

(22) Filed: May 15, 2006

Related U.S. Application Data
(63) Continuation of application No. 09/811,556, filed on Mar. 20, 2001.

(30) Foreign Application Priority Data
Sep. 20, 2000 (JP) 2000-290346

(51) Int. Cl. G06F 17/50

(52) U.S. Cl. 705/7

(57) ABSTRACT

A collection method and system which restrains an increase in initial cost of energy-saving facilities. According to the invention, the reduced amount of running cost of energy-saving facilities for a predetermined period is computed based on a prediction of operation of the facilities, and an initial cost is determined. Actual operation of the energy-saving facilities is monitored, and stored in a history database. Based on the actual operation, the reduced amount of the running cost is periodically calculated and stored in a database. A business enterpriser draws the amount from the customer's account corresponding to the reduced amount.

The present application is a continuation of application Ser. No. 09/811,556, filed Mar. 20, 2001, the contents of which are incorporated herein by reference.

### BACKGROUND OF THE INVENTION

The present invention relates to a method of and a system for causing energy-saving (running-cost-saving) facilities (system) to be introduced into a customer and collecting the costs of the facilities, as in the case of ice storage system providing enterprises.

For example, in the enterprises of providing ice storage systems or the like, when energy-saving facilities (system) are proposed and sold to a customer, the increased amount of the initial cost for the introduction of the energy-saving facilities can be collected as the reduced amount of the running cost of the introduced energy-saving facilities. Accordingly, it is said that the reduced amount of the running cost becomes a profit to the customer after the increased amount of the initial cost has been collected.

However, in general, systems having greater energy-saving effects have entailed higher initial costs and there have been a large number of customers hesitating about whether to adopt energy-saving systems while recognizing the energy-saving effects thereof. In particular, in the case of a system such as an ice storage system for which an system-introducing subsidy is prepared so that an increase in its initial cost can be restrained, there is a risk that if such subsidy institution is abolished, the number of energy-saving systems to be introduced will decrease.

In the enterprises of proposing and selling energy-saving systems to customers, such as conventional enterprises which sell ice storage systems, when an enterpriser is to propose an energy-saving system to a customer, the enterpriser needs to take care that an increase in initial cost does not cause the customer to lose the will to adopt the energy-saving system.

Incidentally, an ESCO (Energy Service Company) enterprise is known as an enterprise similar to this kind of art, and, in general, the ESCO enterprise is currently restrictively applied to the introduction of large-scale facilities into large factories. However, the ESCO enterprise cannot offer its merit to the sale of comparatively small-scale facilities or the like, and is generally difficult to apply it if a great energy-saving effect is not obtained.

### SUMMARY OF THE INVENTION

The invention has been made on the basis of the above-described facts, and provides a collection method of and a collection system for collecting the costs of energy-saving facilities. The collection method and system make it possible to restrain an increase in initial cost at the time of introduction of energy-saving facilities, and can also be applied to facilities whose scale and energy-saving effect are comparatively small, whereby it is possible to promote introduction of energy-saving facilities.

Therefore, in accordance with one aspect of the invention, there is a method of causing energy-saving facilities (system) to be introduced into a customer and collecting the costs of the energy-saving facilities, which method includes the steps of: predicting the reduced amount of running cost of the energy-saving facilities for a predetermined period based on a prediction of operation of a target customer to which the energy-saving facilities are to be sold; selling the energy-saving facilities at a selling price which reflects the predicted reduced amount; and inputting an actual operational status of the energy-saving facilities into a storage device, periodically computing the reduced amount of the running cost for the predetermined period by means of a computing device, and periodically collecting an amount based on the reduced amount of the running cost.

In accordance with another aspect of the invention, there is provided a system for causing energy-saving facilities (system) to be introduced into a customer and collecting the costs of the energy-saving facilities, which system includes: a part which predictively computes the reduced amount of running cost of the energy-saving facilities for a predetermined period based on a prediction of operation of a target customer to which the energy-saving facilities are to be sold; a selling price determining part which determines a selling price (initial cost) which reflects the reduced amount calculated by the predictive computation part; a part which remotely monitors an actual operational status of the sold energy-saving facilities; a computation part which periodically calculates the reduced amount of the running cost for the predetermined period on the basis of an actual operational status of the sold energy-saving facilities, which status is obtained from the remote monitoring part; and a collection part which periodically collects from the customer an amount which reflects the reduced amount of the running cost.

In accordance with yet another aspect of the invention, there is provided a collection system which includes: an operation data holding and storing server provided with a database in which data including operation data of facilities of a customer and the amount of use of energy is recorded in the form of history; a business enterpriser terminal which acquires and stores via communication means (the Internet or a communication line) the data of the facilities of the customer stored in the operation data holding and storing server; a calculation part which calculates the reduced amount of running cost of the facilities from the operation data and the amount of use of energy; and a communication part which notifies a financial institution terminal of data indicative of the reduced amount of the running cost in order to cause the reduced amount of the running cost calculated by the calculation part to be drawn from an account of the customer and to be transferred to an account of the business enterpriser.

The collection system may further include a part which notifies a terminal of the customer of an amount to be drawn from the account of the customer as well as the balance of repayment, via the Internet.

The collection system may be constructed so that in the case where the balance of repayment becomes equal or close to zero, a notification indicative of the completion of repayment is transmitted from the business enterpriser terminal to the terminal of the customer via the Internet.

Moreover, the reduced amount of the running cost may be calculated on the basis of facility operation cost prepared on the basis of the operation data of existing facilities of the customer. Alternatively, the reduced amount of the running cost may be calculated on the basis of a representative operation pattern selected according to the scale of the facilities. In the latter case, the collection system may be provided with a part which stores plural representative operation patterns, selects an approximate pattern from among the representative operation patterns according to the scale of the facilities, and calculates the reduced amount of the running cost on the basis of the selected representative operation pattern.

Incidentally, a collection period during which to collect the reduced amount of the selling price (initial cost) of the facilities sold to the customer may be a predetermined period obtained by trial calculation in advance or a period which passes until a cumulative value of the reduced amount of the running cost reaches the reduced amount of the selling price (initial cost).

The collection system may be constructed to include a part which remotely measures the amount of use of energy of the facilities, actually calculates the reduced amount of the running cost of the facilities, and notifies the terminal of the customer of the reduced amount of the running cost via the Internet.

In accordance with yet another aspect of the invention, there is provided a system for causing energy-saving facilities to be introduced into a customer and collecting the costs of the energy-saving facilities, which system includes: a part which predictively computes the reduced amount of running cost of the energy-saving facilities for a predetermined period based on a prediction of operation of a target customer to which the energy-saving facilities are to be leased; a lease charge determining part which determines a lease charge to reflect the reduced amount calculated by the predictive computation part; a part which remotely monitors an actual operational status of the leased energy-saving facilities; a computation part which periodically calculates the reduced amount of the running cost for the predetermined period on the basis of an actual operational status of the leased energy-saving facilities, which status is obtained from the remote monitoring part; and a collection part which periodically collects from the customer an amount which reflects the reduced amount of the running cost.

In the collection system, the collection part which periodically collects from the customer the amount which reflects the reduced amount of the running cost is effectively realized by determining the lease charge inclusive of a flat-rate energy charge.

As described above, the invention solves the above-described problem by making a trial calculation of the reduced amount of running cost obtainable for a predetermined period by the introduction of energy-saving facilities, delivering the energy-saving facilities at a price determined by subtracting the reduced amount of the running cost from the initial cost of the facilities, and then collecting from the customer the reduced amount of the running cost obtainable when the facilities are actually in operation.

Accordingly, as compared with the conventional case in which a customer collects the increased amount of the initial cost of introduced energy-saving facilities with the reduced amount of the running cost thereof, a customer can reduce the amount of initial investment and can therefore readily adopt energy-saving facilities. Accordingly, the invention is also effective in the spreading of energy-saving facilities.

### BRIEF DESCRIPTION OF THE DRAWINGS

The scope of the present invention will be apparent from the following detailed description, when taken in conjunction with the accompanying drawings, and such detailed description and specific examples, while indicating example embodiments of the invention, are given by way of illustration only, since various changes and modifications within the spirit and scope of the invention will become apparent to those skilled in the art from this detailed description in which:

FIG. 1 is a flowchart illustrating a first embodiment of the invention;

FIG. 2 is a schematic view of a system construction, illustrating the first embodiment of the invention;

FIG. 3 is a flowchart illustrating a second embodiment of the invention;

FIG. 4 is a flowchart illustrating a third embodiment of the invention;

FIG. 5 is a flowchart illustrating a fourth embodiment of the invention; and

FIG. 6 is a flowchart illustrating a fifth embodiment of the invention.

### DETAILED DESCRIPTION OF THE INVENTION

Preferred embodiments of the invention will be described below with reference to the accompanying drawings.

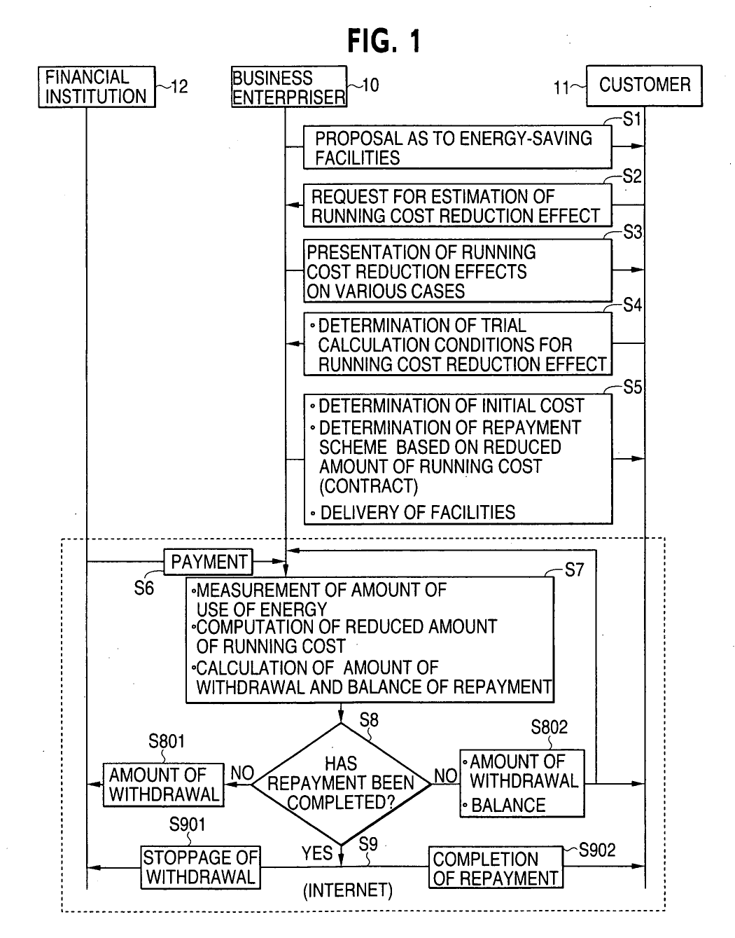

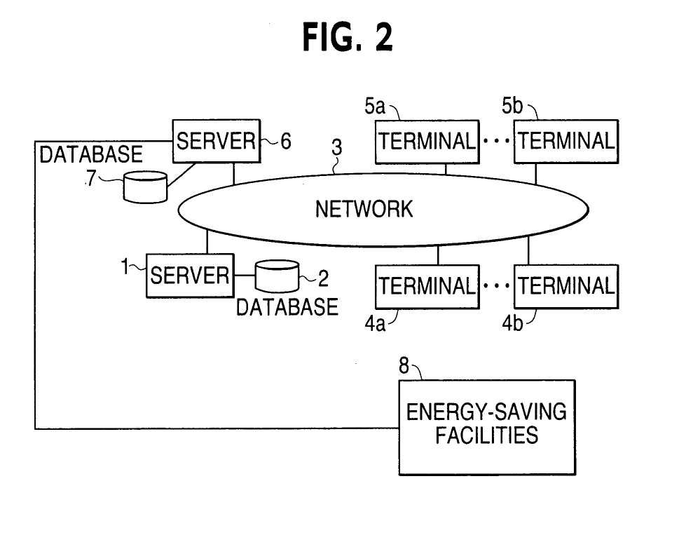

A first embodiment of the invention will be described with reference to FIGS. 1 and 2.

The entire flow of the first embodiment will be described below with reference to FIG. 1. First of all, a business enterpriser 10 that sells or leases energy-saving facilities (system) proposes energy-saving facilities associated with production facilities and air-conditioning facilities for a factory or air-conditioning facilities for an office building, to a customer 11 that is the owner of the factory or the like (S1). At this time, the business enterpriser may also present a currently operating actual example of the past sold energy-saving facilities or an example of a trial calculation of an energy-saving effect achievable on the assumption that the desired energy-saving facilities are applied to the facilities (system) of the customer. If the customer is to make a detailed examination as to the adoption of the energy-saving facilities, the customer in general requests the business enterpriser to make a detailed estimation of the running cost reduction effect of the energy-saving facilities (S2). Then, the business enterpriser performs a trial calculation on the reduction effect (reduced amount) of the running cost obtainable when proposed energy-saving facilities are operated for a predetermined period, on the basis of the operation data of the existing facilities of the customer or a representative operation pattern corresponding to the scale of the facilities owned by the business enterpriser. In this trial calculation, the business enterpriser performs computations on the case where the existing facilities of the customer are continuously used and on the case where the energy-saving facilities proposed by the business enterpriser are adopted (the representative operation pattern or the like is used). In addition, the business enterpriser presents the running cost reduction effect to the customer for each of various cases based on the combination of the operating periods of the proposed energy-saving facilities (for example, whether the trial calculation is based on 3 years or 5 years) (S3). It is most preferable that the operation data, which serves a reference for the trial calculation of the running cost reduction effect, be calculated by using the measured data of the existing facilities before introduction of new facilities. In the case where the customer has no measured data (operation data) of the existing facilities or the measurement by the customer is insufficient, the business enterpriser may make measurements. In the case where the customer is to completely newly introduce facilities, the customer preferably uses as reference operation data the representative operation pattern presented by the business enterpriser.

For the purpose of performing a trial calculation on the running cost reduction effect, the customer determines, on the basis of the results of the trial calculations of the various cases presented by the business enterpriser, operation data to be used as a reference (such as the measured data of the existing facilities) and trial calculation conditions, such as an operation period, for making a trial calculation on the reduced amount of the running cost (S4). On the basis of the result of this trial calculation, the business enterpriser makes a contract to purchase the facilities at a price determined by, for example, subtracting the reduced amount of the running cost from the initial cost of the facilities, and to repay the business enterpriser the reduced amount of the initial cost with the reduced amount of the running cost which is yielded when the facilities are actually in operation, and the business enterpriser delivers the energy-saving facilities to the customer (S5). Until the completion of the repayment of the reduced amount of the initial cost, the customer repays on a fixed amount at periodical intervals, or corresponding to the monthly reduced amount of the running cost. As the operation period becomes longer, the cumulative reduced amount of the running cost becomes larger. Accordingly, by lengthening the repayment period, it is possible to reduce the initial cost by that amount.

If the customer is to repay the reduced amount of the initial cost with the reduced amount of the running cost that is yielded when the facilities are actually in operation, the customer can select a limited-period repayment scheme or a limited-amount repayment scheme. Namely, during the operation period used on the trial calculation of the running cost reduction effect, the customer continues to repay the reduced amount of the initial cost by an actually reduced amount of the running cost for a predetermined period or to repay it until the reduced amount of the initial cost is actually completely paid. In the case of the limited-period repayment scheme, if the installed facilities serve an energy-saving effect greater than a planned value, the business enterpriser can make a greater income, whereas if the energy-saving effect is less than the planned value, the business enterpriser will have a loss. Incidentally, in general, interest is added in either of the schemes.

After having installed the energy-saving facilities to the customer, the business enterpriser receives payment of charges for the installation of the facilities from a financial institution 12 (S6). In addition, the business enterpriser remotely measures the amount of use of energy of the facilities, and records operation data in a database via a server or the like of the business enterpriser. The business enterpriser server periodically computes the reduced amount of the running cost from the stored data, and determines, for example every month, the reduced amount of the running cost or an amount corresponding to the reduced amount as an amount to be drawn from a bank account designated by the customer. In addition, the business enterpriser server calculates the balance of repayment and notifies the customer of the reduced amount and the balance via communication means, while the business enterprise server notifies a system of the financial institution of the amount to be drawn from the customer's bank account and executes a withdrawal from the customer's bank account (S7, S8).

In the case of the limited-period repayment scheme, when the period to collect the reduced amount of the initial cost by repayment of the reduced amount of the running cost reaches a predetermined period, or in the case of the limited-amount repayment scheme, when the customer completes the repayment of the reduced amount of the initial cost, the business enterprise sever notifies the customer of the completion of the repayment and stops the withdrawal from the financial institution (S9).

These series of processes surrounded by dashed lines in FIG. 1 can be efficiently and reliably executed by use of the Internet.

A specific example of a basic system construction that realizes the embodiment shown in FIG. 1 will be described below with reference to FIG. 2. A business enterpriser server 1 connects to a business enterpriser database 2 which stores the information of the customer and the financial institution as well as data such as the operation data and the running cost of the customer's system. These server and terminals (a business enterpriser server 1, a customer terminal 4 (4a, 4b, . . . ) and a financial institution terminal 5 (5a, 5b, . . . )) are connected via the Internet 3. In addition, the Internet 3 connects to an operation data holding and recording server 6 which holds and records the operation data of energy-saving facilities (system) 8 of the customer. The operation data of the customer system is recorded on this operation data holding and recording server 6 in the form of a history database 7.

The business enterpriser server 1 acquires the operation data of the energy-saving facilities 8 installed to the customer, from the operation data holding and recording server 6 connected to the Internet 3, and calculates the running cost of the energy-saving facilities 8 from the amount of use of energy thereof. The business enterpriser server 1 transmits this data to an electronic financial service of the financial institution via the financial institution terminal 5, and is drawn the corresponding amount from the account of the customer and transfers the drawn amount to the account of the business enterpriser. In addition, the business enterpriser sever 1 notifies the customer, for example a customer terminal 4, of the drawn amount and the balance of repayment, for example via the Internet. Upon the completion of repayment, the business enterpriser sever 1 transmits a repayment completion notice to the customer terminals 4 via the Internet 3.

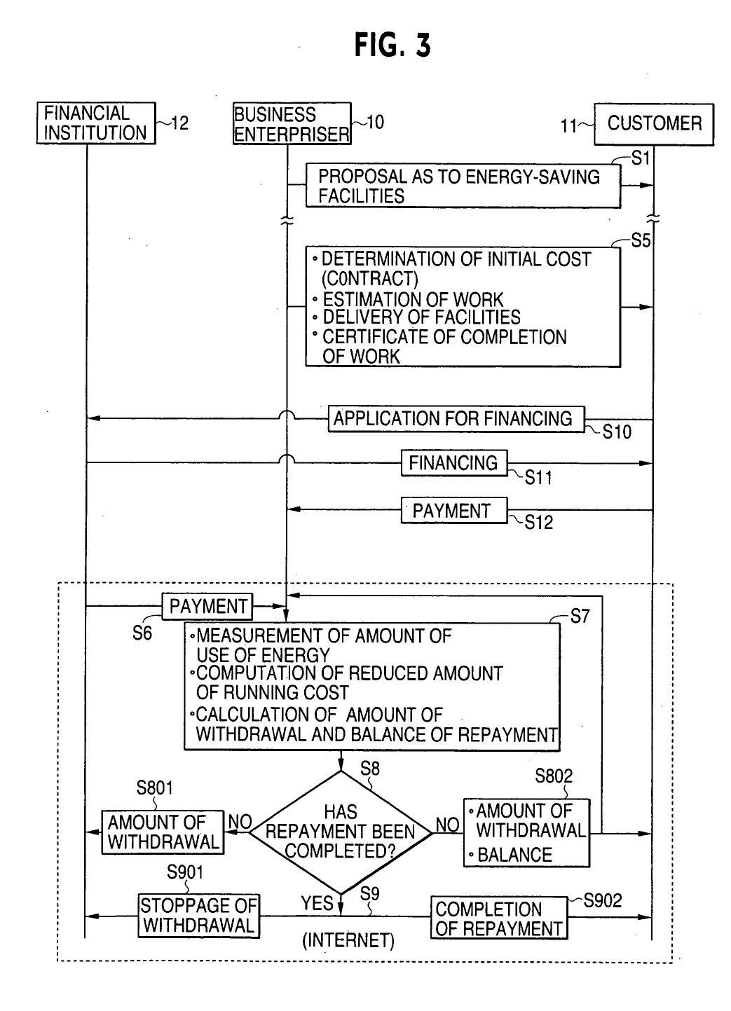

A second embodiment of the invention will be described below with reference to FIG. 3.

The second embodiment relates to an example that enables the customer to utilize various kinds of financing institutions, as in the case of the introduction of an ice storage system. In the second embodiment as well, the steps S1 to S5 for determining initial cost and steps S6 to S9 are approximately the same as the corresponding steps of the embodiment shown in FIG. 1. In the second embodiment, in the above-described step S5, when the business enterpriser installs the facilities, the business enterpriser presents to the customer documents, such as an estimate for work and a certificate of the completion of work, which become necessary when the customer applies for financing. The customer presents these documents to a public organ or a financial institution that becomes an agency of the financing institution of the public organ (S10), and obtains financing (S11). The customer can reduce the amount of repayment by paying the financial amount to the business enterpriser (S12). The business enterpriser server calculates the balance of the customer based on the financing. The other process is similar to that shown in FIG. 1.

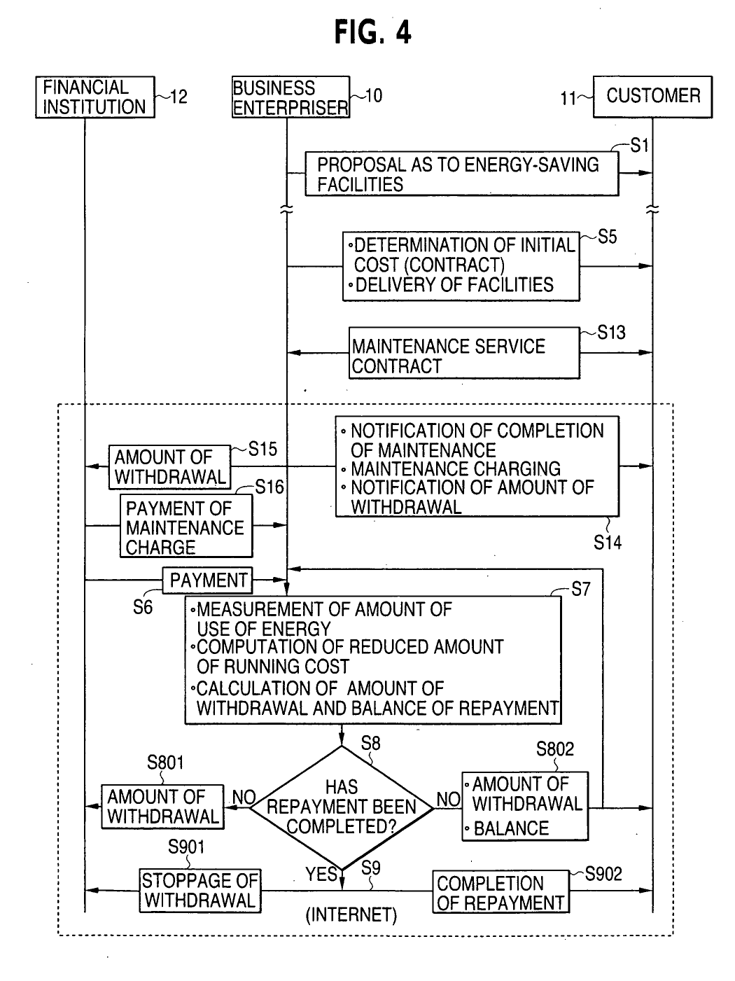

A third embodiment of the invention will be described below with reference to FIG. 4.

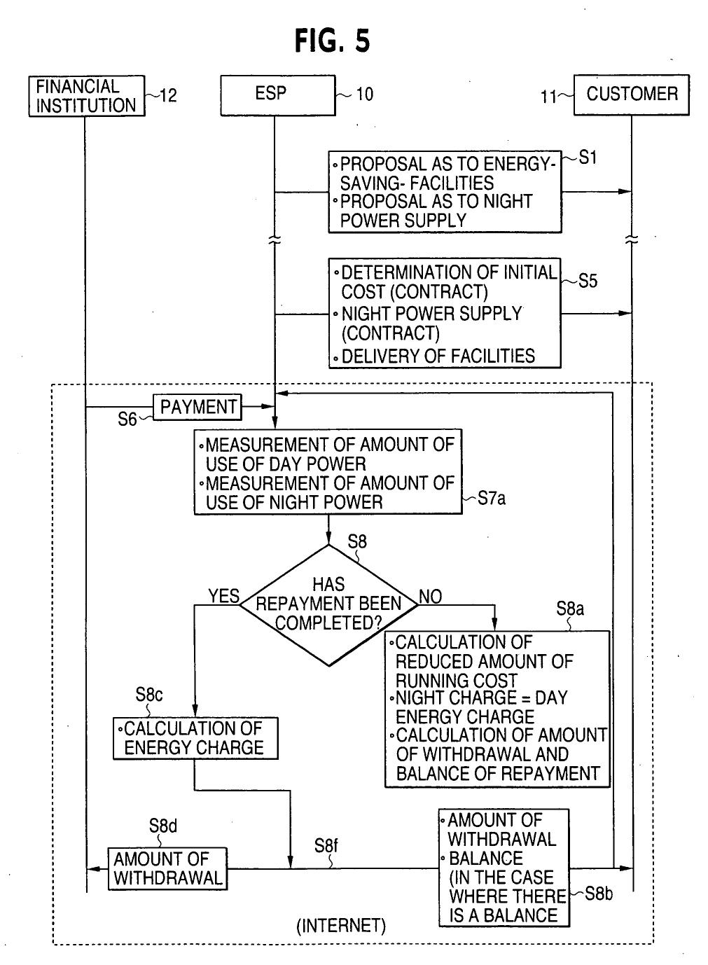

In the third embodiment as well, steps S1 to S5 for determining the initial cost and installing the system and steps S6 to S9 are similar to the corresponding steps of the embodiment shown in FIG. 1. The third embodiment differs from the embodiment shown in FIG. 1 in that a maintenance service contract is made between the business enterpriser and the customer (S13). By making the maintenance service contract, the customer is guaranteed consistently stable operation of the facilities, while the business enterpriser can constantly obtain, for example, a constant amount of income owing to the contract. The business enterpriser notifies the customer of the completion of maintenance, charging, the amount of withdrawal and the like, for example via the Internet (S14), and also notifies the financial institution of the amount of withdrawal for the maintenance service (S15). When receiving this notification, the financial institution pays the maintenance charge into the account or the like of the business enterpriser (S16). (Incidentally, in FIG. 4, the above-described steps S14 to S16 are shown above the step S6 for the convenience of description, but the steps S14 to S16 are normally carried out at adequate positions between the steps S6 and S9.) A fourth embodiment of the invention will be described below with reference to FIG. 5.

The fourth embodiment relates to an example in which the invention is applied to an ESP (Energy Service Provider). Since an ESP 10a performs supply of local electric power, if the ESP 10a is to propose energy-saving facilities (system) which use a large amount of midnight power, such as an ice storage system, a midnight power storage system or a day and night continuous operation system, the ESP 10a can also propose midnight power supply together with such energy-saving facilities (system). Although the steps S1 to S5 for determining the initial cost are approximately similar to the corresponding steps of the embodiment shown in FIG. 1, the fourth embodiment differs from each of the above-described embodiments in that a midnight power supply contract is made between the ESP 10a and the customer at the time of determination of the initial cost of the facilities (S5). In the fourth embodiment, after having installed the system, the ESP server measures the amount of use of day and midnight power and the amount of use of midnight power (S7a), and computes the reduced amount of daytime running cost by means of a computing device and also converts the charge for the use of midnight power in terms of the charge for the use of day power by means of the computing device. The ESP server 10a charges the customer (e.g. a customer terminal) these amounts via communication means such as the Internet (S8a, S8b). The ESP server 10a also notifies the financial institution 12 of an amount to be drawn from the account of the customer (S8d). As for the customer, the use of midnight power leads to a reduction in the running cost, but in the fourth embodiment, unlike any of the above-described embodiments, the difference between the charge for the use of day power and the charge for the use of midnight power is allocated for repayment of the reduced amount of the initial cost of the facility costs, and the ESP 10a collects the reduced amount of the initial cost from the difference charge. After the completion of the repayment of the reduced amount of the initial cost, the ESP server 10a separately calculates the energy charge for day power and the energy charge for midnight power (S8c) and charges the customer these energy charges (S8B, S8d). Accordingly, the customer can subsequently receive the benefit of a reduction in the amount of the running cost due to the use of midnight power. The ESP can promptly collect the reduced amount of the initial cost by selling the midnight power purchased from an existing electric power company or a power retail trader, to the customer as day power. In addition, the ESP has the advantage that it is possible to improve load leveling and the rate of facility operation. And the ESP server can also calculate the amount for repayment of the reduced amount of initial cost considering to the reduced amount of running cost.

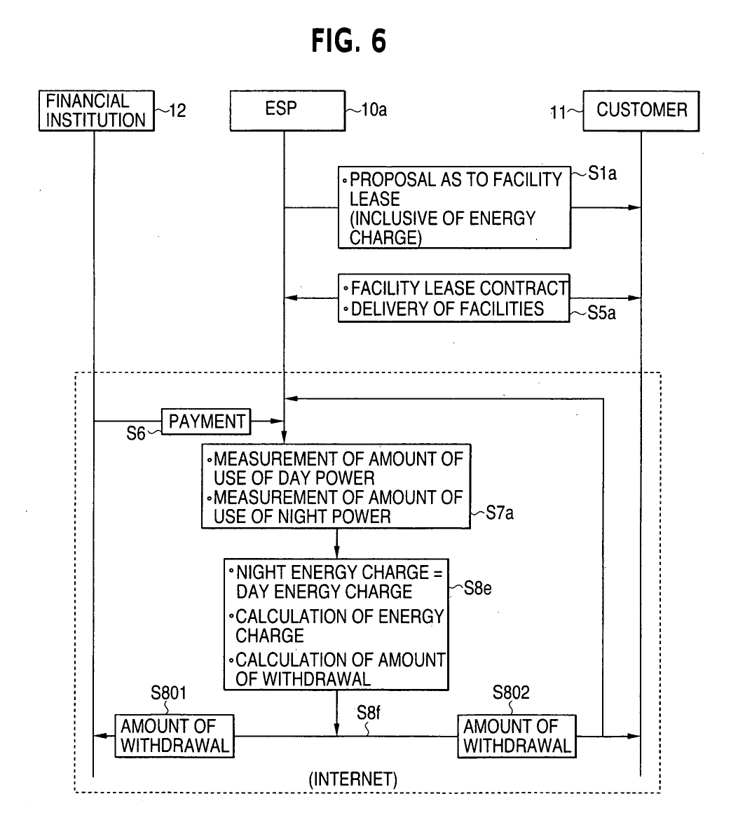

A fifth embodiment of the invention will be described below with reference to FIG. 6. The fifth embodiment differs from each of the above-described embodiments in that the ESP 10a proposes to lease the customer facilities (system) at a charge inclusive of energy charge (S1a), and makes a facility lease contract with the customer (S5a). In the fifth embodiment, after the installing of the leased facilities, the ESP server 10a measures the amount of use of day power and the amount of use of midnight power of the installed facilities (S7a). As in the case of FIG. 5, the ESP server 10a computes the charge for the use of midnight power and the charge for the use of day power at the same rate, and calculates the amount of withdrawal (S8e). The ESP server 10a notifies the customer of the amount of withdrawal, and also notifies the financial institution 12 of the amount to be drawn from the account of the customer, via communication means such as the Internet (S8f).

According to the fifth embodiment, since the system is introduced on lease, the customer 11 need not increase his fixed assets and can achieve a great reduction in system introduction cost. Since the lease charge contains flat-rate energy charge, the ESP 10a can collect the facility costs from the difference between the energy charge for day power and the energy charge for midnight power. Similarly to the embodiment shown in FIG. 5, the fifth embodiment is effective in stabilizing the supply of midnight power and improving the rate of facility operation. In addition, if the ESP 10a is capable of supplying power generated by natural energy such as wind energy, the ESP 10a will be able to supply power generated by natural energy in preference to midnight power, so that the advantage of environmental conservation can also be expected. Moreover, the fifth embodiment also has the advantage that the customer can recognize an energy-saving effect, i.e., a running cost reduction effect, in more practical terms.

According to the invention, the collection method and system are arranged to sell energy-saving facilities at a selling price which reflects the reduced amount of the running cost of these facilities, and periodically collect an amount based on the reduced amount of the running cost. Accordingly, the collection method and system have the advantage of restraining an increase in initial cost at the time of introduction of the energy-saving facilities. In addition, according to the invention, even if the scale or the energy-saving effect of the introduced facilities is comparatively small, the collection method and system are easily applicable. Accordingly, in this respect, the invention is effective in the promotion of introduction of energy-saving facilities.

While the present invention has been described in detail and pictorially in the accompanying drawings it is not limited to such details since many changes and modifications recognizable to those of ordinary skill in the art may be made to the invention without departing from the spirit and the scope thereof.

What is claimed is:

1. A system for collecting the costs of an energy-saving facility installed to a customer, comprising:
means for storing a predicted reduced amount of running cost of the energy-saving facilities for a predetermined period, the reduced amount calculated based on a prediction of operation of a customer;
means for monitoring an actual operational status of the energy-saving facilities;
means for calculating a reduced amount of the running cost on the basis of an actual operational status of the energy-saving facilities, the status is obtained from the remote monitoring part; and
means for collecting from the customer an amount to repay the reduced amount of the running cost which has been subtracted from the initial cost of the energy-saving facility.
